(19) United States
(12) Patent Application Publication
(10) Pub. No.: US 2019/0111621 A1
(43) Pub. Date: Apr. 18, 2019

(54) ADDITIVE MANUFACTURING APPARATUS

(71) Applicant: GENERAL ELECTRIC COMPANY, Schenectady, NY (US)

(72) Inventors: Scott Andrew Weaver, Ballston Lake, NY (US); Anthony Joseph Vinciquerra, Rexford, NY (US)

(21) Appl. No.: 15/787,302

(22) Filed: Oct. 18, 2017

(51) Int. Cl. B29C 64/255; B22F 3/105; B29C 64/153; B33Y 30/00

(52) U.S. Cl. CPC B29C 64/255; B22F 3/1055; B22F 2003/1056; B33Y 30/00; B29C 64/153

(57) ABSTRACT

An additive manufacturing apparatus including a build module is presented. The build module includes a support structure and an integrated build unit formed in the support structure. The integrated build unit includes a chamber; a powder supply compartment comprising a powder material, formed in the chamber; and a build compartment comprising a build platform, formed in the chamber adjacent to the powder supply compartment. A separator is disposed between the powder supply compartment and the build compartment. An additive manufacturing apparatus including a plurality of build modules is also presented.

### BACKGROUND

Embodiments of the disclosure generally relate to an additive manufacturing apparatus. More particularly, embodiments of the disclosure relate to an additive manufacturing apparatus including compact and integrated build units.

Powder bed technologies are some examples of additive manufacturing processes. However, in powder bed technology, as the build takes place in the powder bed, conventional additive manufacturing systems may use a large amount of powder. This may be cost-prohibitive when considering a factory environment using many such systems. The powder that is not directly melted into the part but stored in the neighboring powder beds may be problematic because it may add weight to the piston systems, complicate seals and chamber pressure problems, and the possibility of contamination may increase. Further, some powders required for builds may be scarce and in low quantities.

Accordingly, there remains a need for an additive manufacturing apparatus that allows for minimization of powder usage and wastage in the additive manufacturing apparatus.

### BRIEF DESCRIPTION

In one aspect, the disclosure relates to an additive manufacturing apparatus including a build module. The build module includes a support structure and an integrated build unit formed in the support structure. The integrated build unit includes a chamber: a powder supply compartment comprising a powder material, formed in the chamber; and a build compartment comprising a build platform, formed in the chamber adjacent to the powder supply compartment. A separator is disposed between the powder supply compartment and the build compartment.

In another aspect, the disclosure relates to an additive manufacturing apparatus including a plurality of build modules. Each build module of the plurality of modules includes a support structure and an integrated build unit formed in the support structure. The integrated build unit includes a chamber. The chamber includes a powder supply compartment, formed in the chamber; and a build compartment, formed in the chamber adjacent to the powder supply compartment. A separator is disposed between the powder supply compartment and the build compartment. The powder supply compartment includes a powder material and the build compartment includes a build platform.

These and other features, embodiments, and advantages of the present disclosure may be understood more readily by reference to the following detailed description.

### DRAWINGS

These and other features, aspects, and advantages of the present disclosure will become better understood when the following detailed description is read with reference to the accompanying drawings, wherein:

FIG. 1 illustrates a schematic of an additive manufacturing apparatus, in accordance with some embodiments of the disclosure;

FIG. 2 illustrates a side view of an additive manufacturing apparatus, in accordance with some embodiments of the disclosure;

FIG. 3A illustrates a side view of an additive manufacturing apparatus, in accordance with some embodiments of the disclosure;

FIG. 3B illustrates a side view of an additive manufacturing apparatus, in accordance with some embodiments of the disclosure;

FIG. 3C illustrates a side view of an additive manufacturing apparatus, in accordance with some embodiments of the disclosure;

FIG. 3D illustrates a side view of an additive manufacturing apparatus, in accordance with some embodiments of the disclosure;

FIG. 4 illustrates a schematic of an additive manufacturing apparatus, in accordance with some embodiments of the disclosure;

FIG. 5 illustrates a schematic of an additive manufacturing apparatus, in accordance with some embodiments of the disclosure;

FIG. 6 illustrates a side view of an additive manufacturing apparatus, in accordance with some embodiments of the disclosure;

FIG. 7 illustrates a side view of an additive manufacturing apparatus, in accordance with some embodiments of the disclosure;

FIG. 8 illustrates a side view of an additive manufacturing apparatus, in accordance with some embodiments of the disclosure; and

FIG. 9 illustrates a schematic of an additive manufacturing apparatus, in accordance with some embodiments of the disclosure.

### DETAILED DESCRIPTION

In the following specification and the claims, which follow, reference will be made to a number of terms, which shall be defined to have the following meanings. The singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value solidified by a term or terms, such as “about”, and “substantially” is not to be limited to the precise value specified. In some instances, the approximating language may correspond to the precision of an instrument for measuring the value. Similarly, “free” may be used in combination with a term, and may include an insubstantial number, or trace amounts, while still being considered free of the solidified term. Here and throughout the specification and claims, range limitations may be combined and/or interchanged, such ranges are identified and include all the sub-ranges contained therein unless context or language indicates otherwise.

As mentioned earlier, conventional additive manufacturing processes may result in increased powder usage and wastage. The methods described herein address the noted shortcomings in conventional additive manufacturing apparatus, at least in part, through incorporating a powder supply compartment immediately next to a build platform in a small compact arrangement.

In some embodiments, an additive manufacturing apparatus is presented. The additive manufacturing apparatus includes a build module. The build module includes a support structure and an integrated build unit formed in the support structure. The integrated build unit includes a chamber; a powder supply compartment comprising a powder material, formed in the chamber; and a build compartment comprising a build platform, formed in the chamber adjacent to the powder supply compartment. A separator is disposed between the powder supply compartment and the build compartment.

According to the embodiments described herein, the additive manufacturing apparatus is capable of forming a desired object or structure using an additive manufacturing process. “Additive manufacturing” is a term used herein to describe a process which involves layer-by-layer construction or additive fabrication (as opposed to material removal as with conventional machining processes). Such processes may also be referred to as “rapid manufacturing processes”. The additive manufacturing process forms net or near-net shape structures through sequentially and repeatedly depositing and joining material layers. As used herein the term “near-net shape” means that the additively manufactured structure is formed very close to the final shape of the structure, not requiring significant traditional mechanical finishing techniques, such as machining or grinding following the additive manufacturing process. Additive manufacturing systems and methods include, for example, and without limitation, vat photopolymerization, powder bed fusion, binder jetting, material jetting, sheet lamination, material extrusion, directed energy deposition and hybrid systems. These systems and methods may include, for example, and without limitation, stereolithography; digital light processing; scan, spin, and selectively photocure; continuous liquid interface production; selective laser sintering; direct metal laser sintering; selective laser melting; electron beam melting; selective heat sintering; multi-jet fusion; smooth curvatures printing; multi-jet modeling; laminated object manufacture; selective deposition lamination; ultrasonic additive manufacturing; fused filament fabrication; fused deposition modeling; laser metal deposition; laser engineered net shaping; direct metal deposition; hybrid systems; and combinations of these methods and systems. These methods and systems may employ, for example, and without limitation, all forms of electromagnetic radiation, heating, sintering, melting, curing, binding, consolidating, pressing, embedding, and combinations thereof.

These methods and systems employ materials including, for example, and without limitation, polymers, plastics, metals, ceramics, sand, glass, waxes, fibers, biological matter, composites, and hybrids of these materials. These materials may be used in these methods and systems in a variety of forms as appropriate for a given material and method or system, including for example without limitation, liquids, solids, powders, sheets, foils, tapes, filaments, pellets, liquids, slurries, wires, atomized, pastes, and combinations of these forms.

In certain embodiments, suitable additive manufacturing processes include, but are not limited to, the processes known to those of ordinary skill in the art as direct metal laser melting (DMLM), direct metal laser sintering (DMLS), direct metal laser deposition (DMLD), laser engineered net shaping (LENS), selective laser sintering (SLS), selective laser melting (SLM), electron beam melting (EBM), fused deposition modeling (FDM), binder jet technology, or combinations thereof.

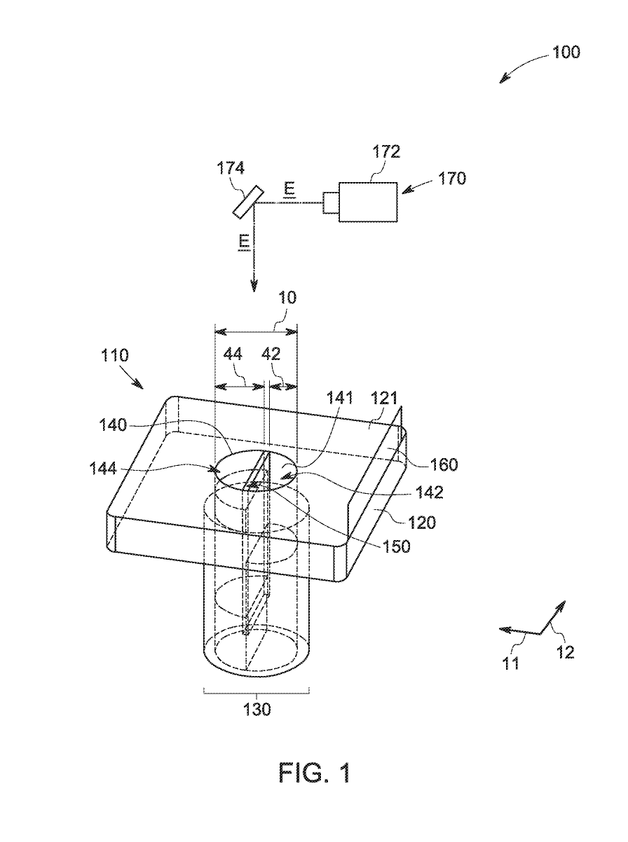

FIG. 1 illustrates an additive manufacturing apparatus 100 in accordance with some embodiments of the present disclosure. As illustrated in FIG. 1, the additive manufacturing apparatus 100 includes a build module 110. The build module 110 includes a support structure 120. The support structure 120 is a rigid structure and defines a work surface 121. In FIG. 1, the support structure 120 is illustrated as having a rectangular cross-section profile, however, any other suitable cross-sectional profiles are also encompassed within the scope of the disclosure. Non-limiting examples of other suitable cross-sectional profiles include any other rectilinear cross-sectional profile (e.g., a square cross-sectional profile, a triangular cross-sectional profile, or a trapezoidal cross-sectional profile), a circular cross-sectional profile, or an oval cross-sectional profile.

The support structure 120 further includes an integrated build unit 130 formed in the support structure 120. The term “integrated build unit” as used herein refers to a build unit including the powder supply compartment and the build compartment adjacent to each other in a compact unit.

Referring again to FIG. 1, the integrated build unit 130 includes a chamber 140. As illustrated in FIG. 1, the chamber 140 includes a chamber opening 141 formed in the worksurface of the support structure 120. The chamber 140 is characterized by a cross-sectional profile that may be a circular cross-sectional profile or a rectilinear cross-sectional profile. Non-limiting examples of suitable rectilinear cross-sectional profiles include a square cross-sectional profile, a rectangular cross-sectional profile, a triangular cross-section profile, or a trapezoidal cross-sectional profile. The example embodiment in FIG. 1 illustrates a circular cross-sectional profile for illustration purposes.

The chamber 140 is further characterized by a cross-sectional dimension 10, for example, a diameter for a circular cross-sectional profile, or a length or breadth for a rectangular cross-sectional profile. The term cross-sectional dimension as used in the context of FIG. 1 refers to a diameter of the chamber 140. In some embodiments, a cross-sectional dimension 10 of the chamber 140 is less than 100 millimeters. Therefore, in the context of a circular cross-sectional profile illustrated in FIG. 1, the cross-section dimension (that is, the diameter) 10 of the chamber 140 is less than 100 millimeters. In some embodiments, a cross-sectional dimension of the chamber 140 is less than 60 millimeters. In certain embodiments, a cross-sectional dimension of the chamber 140 is less than or equal to 50.8 millimeters (2 inches).

With continued reference to FIG. 1, the chamber 140 includes a powder supply compartment 142 formed in the chamber 140 and a build compartment 144 formed in the chamber 140, adjacent to the powder supply compartment 142. The powder supply compartment 142 and the build compartment 144 are separated by a separator 150. This is contrast to conventional build modules employed for additive manufacturing process that include powder supply chambers and build chambers that are spaced apart from each other in the support structure, and are not disposed adjacent to each other. Further, as illustrated in FIG. 1, the powder supply compartment 142 is characterized by a dimension 42 and the build compartment 144 is characterized by a dimension 11. Therefore, as illustrated in FIG. 1, the cross-sectional dimension 10 of the chamber 140 is a sum of the dimension 42 of the powder supply compartment and the dimension 44 of the build compartment 144. As noted earlier, in some embodiments, the sum of the dimensions 42 and 44 is less than 100 millimeters. In some embodiments, the sum of the dimensions 42 and 44 is less than 60 millimeters. In certain embodiments, the sum of the dimensions 42 and 44 is less than or equal to 50.8 millimeters (2 inches). This is contrast to conventional build modules employed for additive manufacturing process that employ compartments with much larger cross-sectional dimensions as employ significantly larger quantities of the powder material.

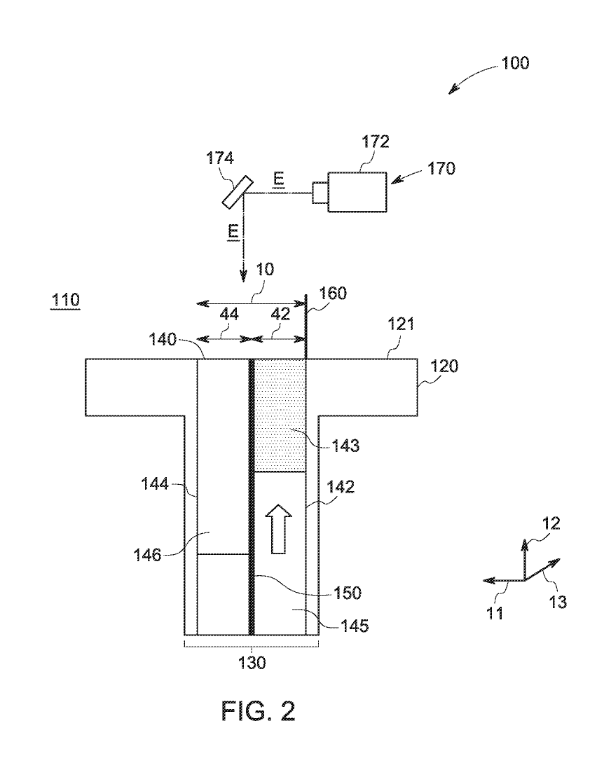

Referring now to FIG. 2, a side-view of the build module 110 of the additive manufacturing apparatus 100, is illustrated. The build module 110 includes a support structure 120 and an integrated build unit 130 formed in the support structure. The integrated build unit 130 includes a chamber 140, a powder supply compartment 142 formed in the chamber 140, and a build compartment 144 formed in the chamber 140, adjacent to the powder supply compartment 142. The powder supply compartment and 142 and the build compartment 144 are separated by a separator 150.

As illustrated in FIG. 2, the powder supply compartment 142 includes a powder material 143. Non-limiting examples of the suitable powder material may include a metallic (including metal alloys) powder, a polymeric powder, a ceramic powder, or combinations thereof. The powder supply compartment 142 further includes a supply piston 145. The supply piston 145 may be any suitable structure that is vertically moveable within the powder supply compartment 142. The supply piston 145 may be further operatively coupled to an actuator (not shown in Figures), operable to selectively move the supply piston 145 up or down.

The build compartment 144 also includes a build platform 146 that is vertically moveable in the build compartment 144. Similar to the supply piston 145, the build platform may be operatively coupled to an actuator (not shown in Figures) that is operable to selectively move the build platform 146 up or down. Non-limiting examples of suitable actuators for the supply piston 145 and the build platform 146 may include pneumatic cylinders, hydraulic cylinders, ballscrew actuators, linear electric actuators, or combinations thereof. Further, the operating principle of the actuators for the supply piston 145 and the build platform 146 may be the same or different.

With continued reference to FIG. 2, the build module 110 further includes a powder applicator 160. In some embodiments, the powder applicator 160 may be a rigid, laterally-elongated structure that is disposed on or contacts the worksurface 121 and is moveable on the worksurface 121. The powder applicator 160 may be operably connected to an actuator (not shown in Figures), and operable to selectively move the powder applicator 160 parallel to the worksurface 121. As depicted in FIG. 2, the powder applicator 160 moves from right to left to supply powder from the powder supply compartment 142 to the build compartment 144. It should be appreciated that the location of the powder supply compartment 142 and the build compartment 144 may be reversed, and the powder applicator 160 may move from left to right to supply powder from the powder supply compartment 142 to the build compartment 144.

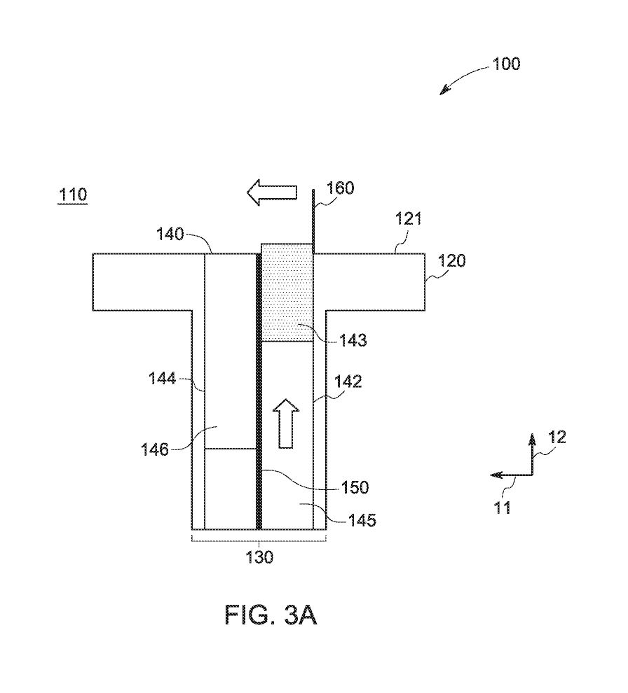

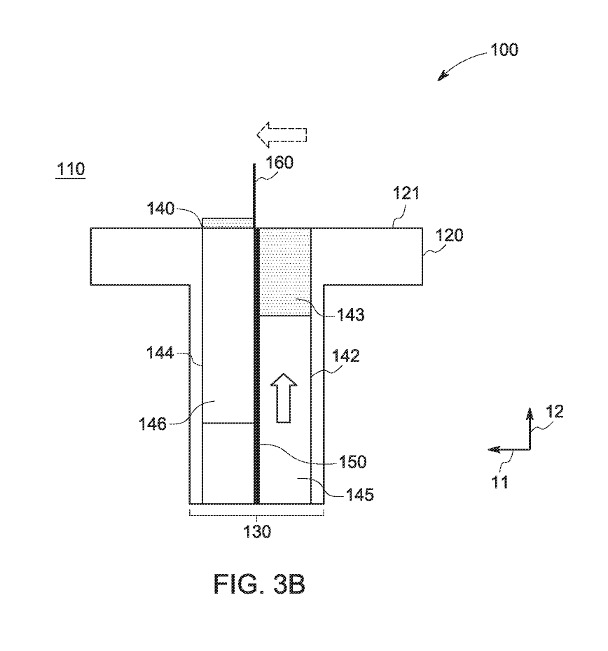

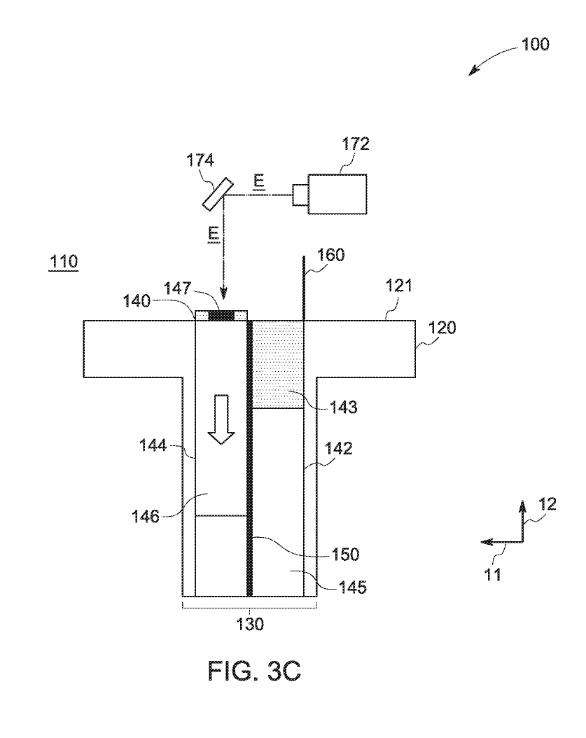

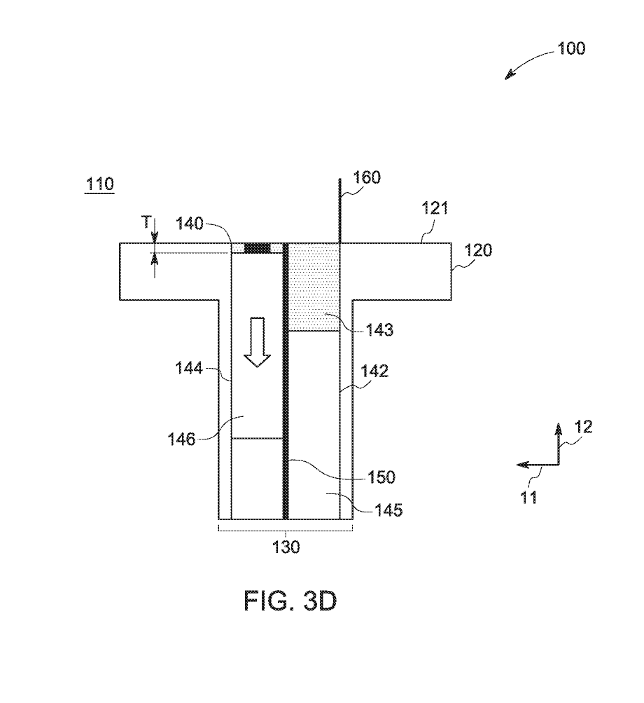

Referring now to FIGS. 1 and 2, the additive manufacturing apparatus 100 further includes an energy module 170. The energy module 170 includes a directed energy source 172 configured to direct an energy beam “F” onto the powder material 143 distributed on the build platform 146, to form a build layer 147 (shown in FIG. 3C).

The directed energy source 172 may include any device operable to generate a beam of suitable power and other operating characteristics, to melt and fuse the powder during the build process, described in more detail below. Suitable directed energy sources include, but are not limited to, laser device, an electron beam device, an infra-red (IR) device, an ultra-violet (UV) device, or combinations thereof. The laser device includes any laser device operating in a power range and other operating conditions for melting the powder material 143, such as, but not limited to, a fiber-optic laser, a CO₂ laser, or a ND-YAG laser.

In some embodiments, a beam steering apparatus 174 may also be used to direct the energy beam from the directed energy source 172. The beam steering apparatus may include one or more mirrors, prisms, or lenses. The beam-steering apparatus may be further operatively coupled to one or more actuators (not shown in Figures), and arranged so that an energy beam from the directed energy source 172 can be focused to a desired spot size and steered to a desired position in an X-Y plane coincident with the worksurface 121.

The operation of the additive manufacturing apparatus 100, in accordance with some embodiments of the present disclosure, is further described in the context of FIGS. 3A-3D, with respect to one build cycle. As shown in FIG. 3A, the supply piston 145 in the powder supply compartment 142 is configured to supply a required amount of the powder material 143 from the powder supply compartment 142 to a powder applicator 160. As illustrated in FIG. 3A, when the supply piston 145 is moved upward (direction 12) in the powder supply compartment 142, a required amount of the powder material 143 may be raised and exposed above the worksurface 121. The amount of powder material that is exposed above the worksurface may be controlled by suitable actuators (not shown in Figures). Further, the amount of powder material supplied by the supply piston 145 may be sufficient for a build layer 147 (described in detail later). As noted earlier, in certain embodiments, the powder supply compartment 142 may contain the powder material 143 sufficient to form a part and not in excess, thereby potentially minimizing powder wastage.

Referring now to FIG. 3B, the powder applicator 160 is configured to distribute the supplied powder material 143 on the build platform 146 of the build compartment 144. Therefore, during a build cycle, after the required amount of powder material 143 is supplied by the supply piston 145 to the powder applicator 160, the powder applicator 160 moves in the horizontal direction (direction 11) and deposits the supplied powder material on the build platform 146. The directed energy source 172 directs an energy beam “E” onto the powder material distributed on the build platform 146, to form a build layer 147, as shown in FIG. 3C.

After a build layer 147 is formed, the build platform 146 is configured to move vertically downward by a build layer thickness “T” increment as shown in FIG. 3D, thus completing a build cycle. In the subsequent build cycle, the supply piston 145 is configured to supply a required amount of the powder material 143 to form a subsequent build layer 147, from the powder supply compartment 142 to the powder applicator 160. The powder applicator 160 is configured to distribute the supplied powder material on the build platform 146 of the build compartment 144, and the directed energy source 172 is configured to direct an energy beam “E” onto the powder material distributed on the build platform 146, to form the subsequent build layer 147. The build cycles may be repeated until the desired part is completed.

In some embodiments, an additive manufacturing apparatus including a plurality of build modules, as described herein above, is also presented. Each build module of the plurality of modules includes a support structure and an integrated build unit formed in the support structure. The integrated build unit includes a chamber. The chamber includes a powder supply compartment, formed in the chamber; and a build compartment, formed in the chamber adjacent to the powder supply compartment. A separator is disposed between the powder supply compartment and the build compartment. The powder supply compartment includes a powder material and the build compartment includes a build platform.

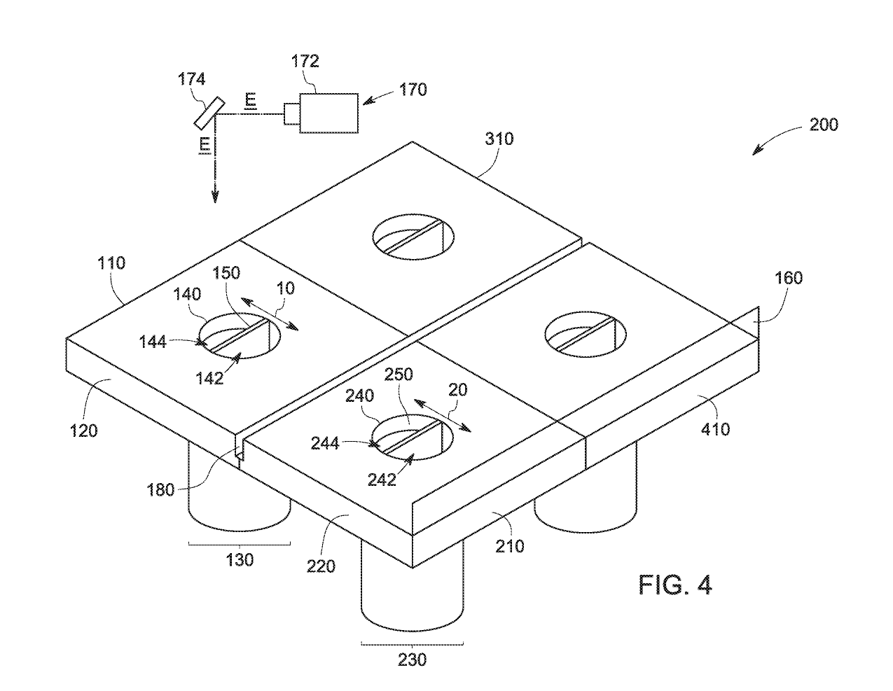

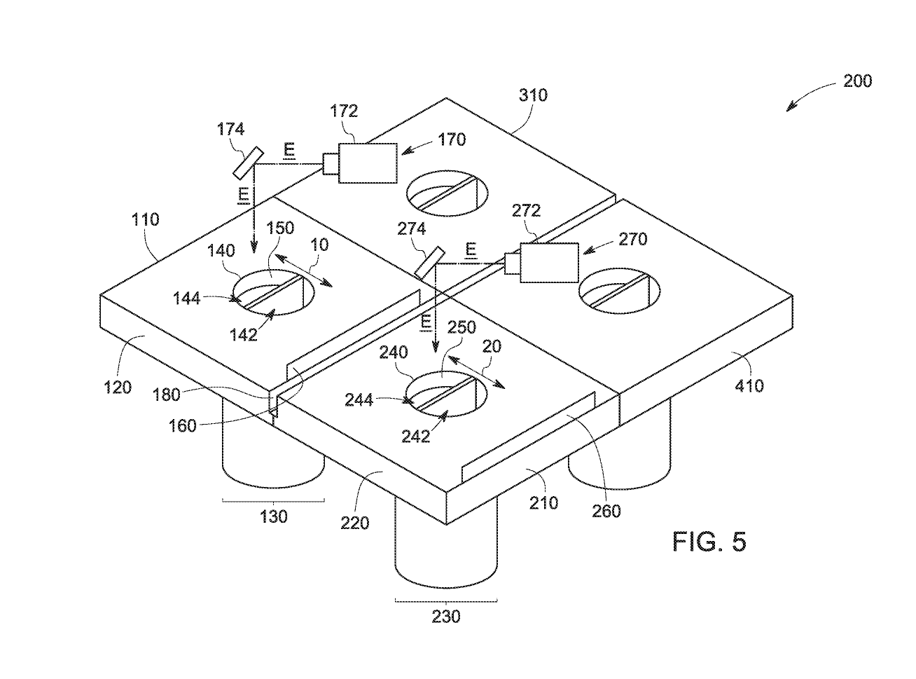

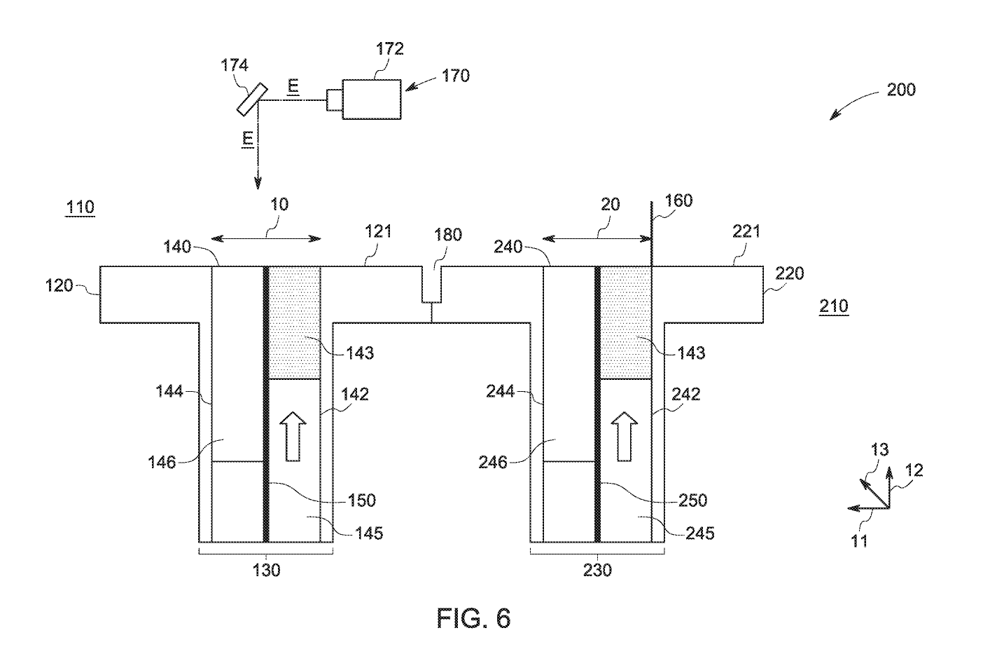

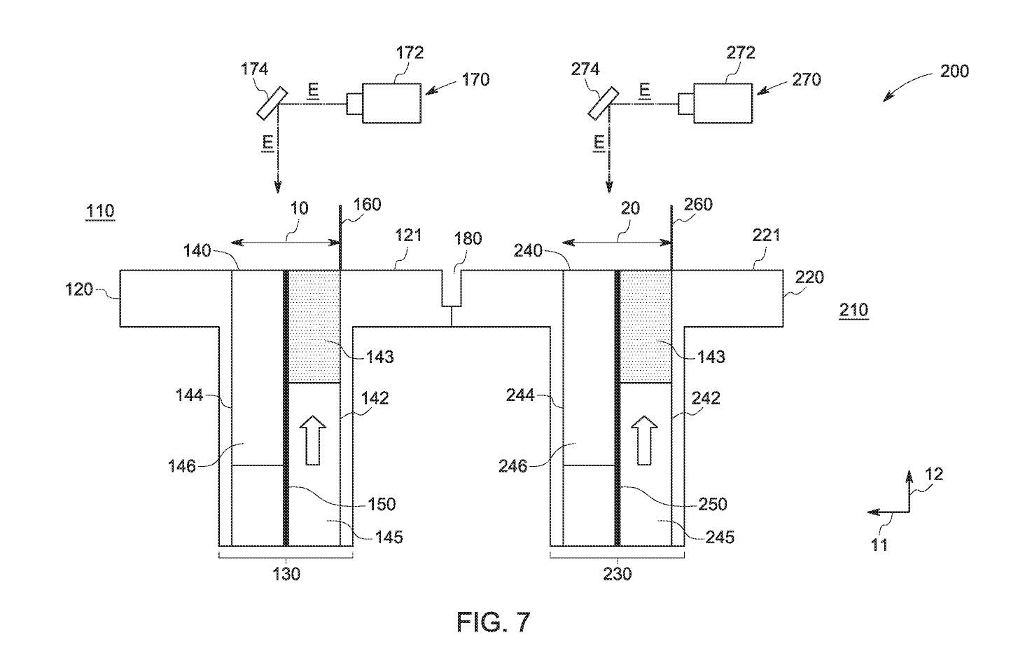

FIGS. 4 and 5 illustrate an additive manufacturing apparatus 200 including a plurality of build modules 110. 210, 310, and 410, in accordance with some embodiments of the disclosure. FIGS. 4 and 5 illustrate four build modules for illustration purposes only, and the additive manufacturing apparatus 200 may include any suitable number of build modules. In some embodiments, the additive manufacturing apparatus 200 includes 4 to 100 build modules. In some embodiments, the additive manufacturing apparatus 200 includes 6 to 60 build modules. In certain embodiments, the additive manufacturing apparatus 200 includes 4 to 40 build modules. In certain embodiments, the additive manufacturing apparatus 200 is configured to simultaneously manufacture a plurality of parts using the plurality of build modules 110, 210, 310, and 410. FIGS. 6 and 7 illustrate the side-views of the additive manufacturing apparatus of FIGS. 4 and 5

As noted earlier, each build module of the plurality of build modules includes an integrated build unit, described herein earlier. Build modules 110 and 210 are described herein in detail. However, the description of build modules 110 and 210 also applies to build modules 310 and 410.

With continued reference to FIGS. 4 and 5, the build module 110 includes a support structure 120 and an integrated build unit 130 formed in the support structure 120. The integrated build unit 130 includes a chamber 140. The chamber 140 includes a powder supply compartment 142, formed in the chamber 140; and a build compartment 144, formed in the chamber 140 adjacent to the powder supply compartment 142. A separator 150 is disposed between the powder supply compartment 142 and the build compartment 144.

Similarly, the build module 210 includes a support structure 220 and an integrated build unit 230 formed in the support structure 220. The integrated build unit 230 includes a chamber 240. The chamber 240 includes a powder supply compartment 242, formed in the chamber 240; and a build compartment 244, formed in the chamber 240 adjacent to the powder supply compartment 242. A separator 250 is disposed between the powder supply compartment 242 and the build compartment 244.

As illustrated in FIGS. 6 and 7, the powder supply compartments 142, 242 include a powder material 143, 243, respectively; and the build compartments 144, 244 include a build platform 146, 246, respectively. The powder supply compartments 142, 144 further include a supply piston 145, 245, respectively. The supply pistons 145, 245 may be any suitable structures that are vertically moveable within the powder supply compartments 142, 242. The supply pistons 145, 245 may be further operatively coupled to an actuator (not shown in Figures), operable to selectively move the supply pistons 145, 245, up or down.

Similar to the supply pistons 145, 245, the build platforms 146, 246 may be each operatively coupled to an actuator (not shown in Figures) that is operable to selectively move the build platforms 146, 246, up or down. Non-limiting examples of suitable actuators for the supply pistons 145, 245 and the build platforms 146, 246 may include pneumatic cylinders, hydraulic cylinders, ballscrew actuators, linear electric actuators, or combinations thereof. Further, the operating principles of the actuators for the supply pistons 145, 245 and the build platforms 146, 246 may be the same or different.

In some embodiments, the powder material in the powder supply compartments of each build module of the plurality of build modules is the same. In some such embodiments, the additive manufacturing apparatus 200 may be configured to build same type of parts. In some embodiments, the powder material in the powder supply compartments of at least two of the build modules of the plurality of build modules is different. In some such embodiments, the additive manufacturing apparatus 200 may be configured to build at least two different type of parts. In some embodiments, the powder material in the powder supply compartments of all the build modules of the plurality of build modules is different. Non-limiting examples of the suitable powder material may include a metallic (including metal alloys) powder, a polymeric powder, a ceramic powder, or combinations thereof.

Referring again to FIGS. 4 and 5, the chambers 140 and 240 are further characterized by a cross-sectional profile that may be a circular cross-sectional profile or a rectilinear cross-sectional profile. The example embodiment in FIG. 4 illustrates a circular cross-sectional profile for illustration purposes only. In some embodiments, at least one chamber in the plurality of build modules has a circular cross-sectional profile. In some embodiments, at least one chamber in the plurality of build modules has a rectilinear cross-sectional profile.

The chambers 140 and 240 are further characterized by a cross-sectional dimension 10 and 20, respectively. The cross-sectional dimension, for example, may be a diameter for a circular cross-sectional profile, or a length or breadth for a rectangular cross-sectional profile. The term “cross-sectional dimension” has been described in detail earlier. In some embodiments, a cross-sectional dimension 10, 20 of the chambers 140, 240 is less than 100 millimeters. Therefore, in the context of a circular cross-sectional profile illustrated in FIG. 4, the cross-section dimension (that is; the diameter) 10, 20 of the chambers 140, 240 is less than 100 millimeters. In some embodiments, a cross-sectional dimension 10,20 of the chambers 140, 240 is less than 60 millimeters. In certain embodiments, a cross-sectional dimension 10, 20 of the chambers 140, 240 is less than or equal to 50.8 millimeters (2 inches).

In some embodiments, the additive manufacturing apparatus 200 further includes a powder applicator configured to distribute a required amount of the powder material from the powder supply compartment to the build platform in the build compartment of each build module of the plurality of build modules.

Referring now to FIGS. 4 and 6, the additive manufacturing apparatus further include a powder applicator 160. The operation of powder applicator 160 is described in the context of build modules 110 and 210. However, the same operating principle applies for build modules 310 and 410 as well, and the powder applicator is configured to distribute the powder material on the build platforms of the build modules 310 and 410 as well. The powder applicator 160 in such instances moves in the x-y plane (directions 11 and 13 shown in FIGS. 6) to simultaneously distribute powder material from the supply compartments to the build platforms of the additive manufacturing apparatus 200.

The powder applicator 160 may be a rigid, laterally-elongated structure that is disposed on the worksurface 221 and is moveable on the worksurfaces 121, 221. The powder applicator 160 may be operably connected to an actuator (not shown in Figures), and operable to selectively move the powder applicator 160 parallel to the work surfaces 121, 221. As depicted in FIGS. 4 and 6, the powder applicator 160 moves from right to left to supply powder from the powder supply compartments 142, 242 to the build compartments 144, 244. It should be appreciated that the location of the powder supply compartments 142, 242 and the build compartments 144, 244 may be reversed, and the powder applicator 160 may move from left to right in such instances. In some embodiments, the additive manufacturing apparatus may further include a powder collection chamber 180, disposed between adjacent build modules, as illustrated in FIGS. 4 and 5.

In some embodiments, the additive manufacturing apparatus 200 further includes an energy module including a directed energy source. The additive manufacturing apparatus is configured to direct an energy beam “E” onto the powder material distributed on the build platform in the build compartment of each build module of the plurality of build modules, to form a plurality of build layers.

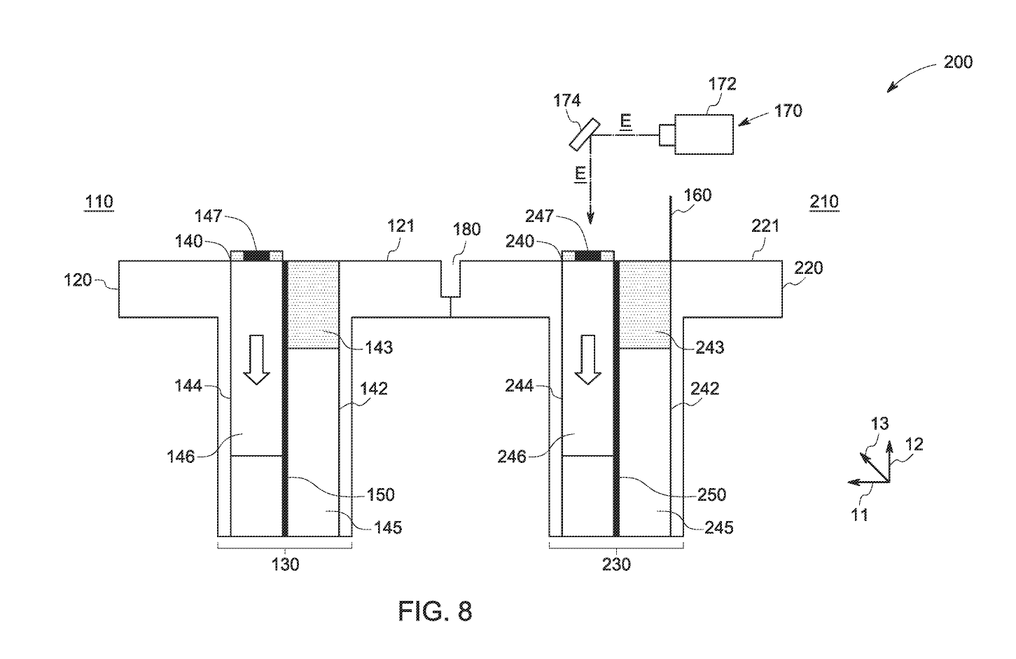

With continued reference to FIGS. 4 and 6, the additive manufacturing apparatus 200 illustrated in FIGS. 4 and 6, further includes an energy module 170. The energy module 170 includes a directed energy source 172 configured to direct an energy beam “E” onto the powder material 143, 243 distributed on the build platforms 146, 246 to form build layers 147, 247 (shown in FIG. 8). The directed energy source 172 may include any device operable to generate a beam of suitable power and other operating characteristics to melt and fuse the powder during the build process, described in more detail earlier. In some embodiments, a beam steering apparatus 174 may also be used to direct the energy beam from the directed energy source 172, to form the build layers 147, 247, as illustrated in FIGS. 6 and 8. In the embodiments illustrated in FIGS. 4, 6 and 8, a single energy module 170 is employed to form the plurality of build layers. Therefore, in such instances, the energy module 170 may be configured to move in the x-y plane (directions 11 and 13 shown in FIGS. 6 and 8). In such instances, the additive manufacturing apparatus 200 is therefore configured to form the plurality of build layers and the parts in a sequential manner.

In some embodiments, each build module of the plurality of build modules in the additive manufacturing apparatus 200 includes a powder applicator. Each powder applicator in the plurality of build module sis configured to distribute a required amount of the powder material from the powder supply compartment to the build platform in the build compartment of the corresponding build module of the plurality of build modules.

Referring now to FIGS. 5 and 7, the additive manufacturing apparatus 200 further include a plurality of powder applicators 160, 260. The operation of powder applicators 160, 260 is described in the context of build modules 110 and 210. However, the same operating principle applies for build modules 310 and 410 as well, and the additive manufacturing apparatus 200 further includes powder applicators (not shown in Figures) configured to distribute the powder material on the build platforms of the build modules 310 and 410 as well.

The powder applicators 160, 260 may be rigid, laterally-elongated structures that are disposed on or contact the worksurfaces 121, 221, respectively; and are moveable on the worksurfaces 121, 221, respectively. The powder applicators 160, 260 may be operably connected to respective actuators (not shown in Figures), and operable to selectively move the powder applicators 160, 260 parallel to the worksurfaces 121, 221. As depicted in FIGS. 5 and 7, the powder applicators 160, 260 move from right to left to supply powder from the powder supply compartments 142, 242 to the build compartments 144, 244. It should be appreciated that the location of the powder supply compartments 142, 242 and the build compartments 144, 211 may be reversed, and the powder applicators 160, 260 may move from left to right in such instances. Further, it should be noted that in the embodiments, illustrated in FIGS. 5 and 7, the powder applicators 160, 260 may be configured to distribute the powder material simultaneously or sequentially to the build platforms of individual build modules.

In some embodiments, the additive manufacturing apparatus 200 further includes a plurality of energy modules. Each energy module of the plurality of energy modules includes a directed energy source configured to direct an energy beam “E” onto the powder material distributed on the build platform in the build compartment of the corresponding build module of the plurality of build modules, to form a plurality of build layers.

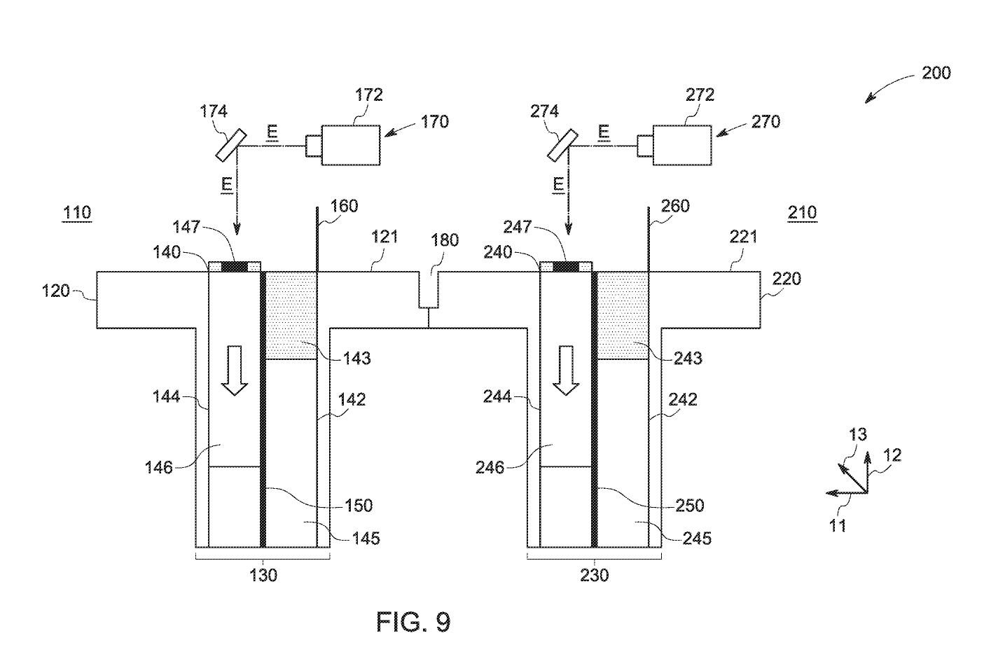

With continued reference to FIGS. 5 and 7, the additive manufacturing apparatus 200 illustrated in FIGS. 5 and 7, further includes a plurality of energy modules 170, 270. The energy modules 170, 270 include a directed energy source 172, 272 configured to direct an energy beam “E” onto the powder material 143, 243 distributed on the build platforms 146, 246 to form build layers 147, 247 (shown in FIG. 9). The directed energy sources 172, 272 may include any device operable to generate a beam “E” of suitable power and other operating characteristics to melt and fuse the powder during the build process, described in more detail earlier. In some embodiments, a beam steering apparatus 174, 274 may also be used to direct the energy beam from the directed energy source 172, 272 to form the build layers 147, 247, as illustrated in FIGS. 5, 7 and 9. The energy modules 170, 270 may direct the energy beam “E” to the distributed powder material in a sequential or simultaneous manner. Further, it should be noted that in the embodiments, illustrated in FIGS. 5 and 7, the additive manufacturing apparatus 200 is configured to form the plurality of build layers and the parts in a sequential manner or a simultaneous manner.

Referring now to FIGS. 4-9, in some embodiments, each build module of the plurality of build modules may be configured to faun a build layer of the same thickness. In some other embodiments, at least two build modules of the plurality of modules may be configured to form a build layer of a different thickness. A thickness of the build layer may be controlled by controlling the amount of powder material distributed from the supply compartment to the build platform of the corresponding build compartment in the build module.

The operation of a build module in the plurality of build modules of FIGS. 4-9 may be similar to the operating principle described earlier in the context of FIGS. 3A-3D.

The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present disclosure. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. An additive manufacturing apparatus comprising a build module, the build module comprising:
a support structure;
an integrated build unit formed in the support structure, the integrated build unit comprising:
a chamber;
a powder supply compartment comprising a powder material, formed in the chamber;
a build compartment comprising a build platform, formed in the chamber adjacent, to the powder supply compartment; and
a separator disposed between the powder supply compartment and the build compartment.

2. The additive manufacturing apparatus of claim 1, wherein the chamber is characterized by a cross-sectional dimension that is less than 100 millimeters.

3. The additive manufacturing apparatus of claim 1, wherein the powder supply compartment further comprises a supply piston configured to supply a required amount of the powder material to form a build layer, from the powder supply compartment to a powder applicator configured to distribute the supplied powder material on the build platform of the build compartment.

4. The additive manufacturing apparatus of claim 3, further comprising an energy module comprising a directed energy source configured to direct an energy beam onto the powder material distributed on the build platform, to form a build layer.

5. The additive manufacturing apparatus of claim 4, wherein the build platform is configured to move vertically downward by a build layer thickness increment, the supply piston is configured to supply a required amount of the powder material to form a subsequent build layer, from the powder supply compartment to the powder applicator configured to distribute the supplied powder material on the build platform of the build compartment, and the directed energy source is configured to direct an energy beam onto the powder material distributed on the build platform, to form the subsequent build layer.

6. The additive manufacturing apparatus of claim 1, wherein the chamber has a circular cross-sectional profile or a rectilinear cross-sectional profile.

7. An additive manufacturing apparatus comprising a plurality of build modules, each build module of the plurality of build modules comprising:
a support structure;
an integrated build unit formed in the support structure, the integrated build unit comprising:
a chamber;
a powder supply compartment comprising a powder material, formed in the chamber;
a build compartment comprising a build platform, formed in the chamber adjacent to the powder supply compartment; and
a separator disposed between the powder supply compartment and the build compartment.

8. The additive manufacturing apparatus of claim 7, wherein the chamber is characterized by a cross-sectional dimension that is less than 100 millimeters.

9. The additive manufacturing apparatus of claim 7, wherein the plurality of build modules comprises 4 to 100 build modules.

10. The additive manufacturing apparatus of claim 7, wherein the additive manufacturing apparatus is configured to simultaneously manufacture a plurality of parts using the plurality of build modules.

11. The additive manufacturing apparatus of claim 7, wherein the powder material in the powder supply compartments of each build module of the plurality of build modules is the same.

12. The additive manufacturing apparatus of claim 7, wherein the powder material in the powder supply compartments of at least two of the build modules of the plurality of build modules is different.

13. The additive manufacturing apparatus of claim 7, further comprising a powder applicator configured to distribute a required amount of the powder material from the powder supply compartment to the build platform in the build compartment of each build module of the plurality of build modules.

14. The additive manufacturing apparatus of claim 7, wherein each build module of the plurality of build modules comprises a powder applicator configured to distribute a required amount of the powder material from the powder supply compartment to the build platform in the build compartment of the corresponding build module of the plurality of build modules.

15. The additive manufacturing apparatus of claim 7, further comprising an energy module comprising a directed energy source configured to direct an energy beam onto the powder material distributed on the build platform in the build compartment of each build module of the plurality of build modules, to form a plurality of build layers.

16. The additive manufacturing apparatus of claim 7, further comprising a plurality of energy modules, each energy module of the plurality of energy modules includes a directed energy source configured to direct an energy beam onto the powder material distributed on the build platform in the build compartment of the corresponding build module of the plurality of build modules, to form a plurality of build layers.

17. The additive manufacturing apparatus of claim 7, wherein each build module of the plurality of build modules is configured to form a build layer of the same thickness.

18. The additive manufacturing apparatus of claim 7, wherein at least two build modules of the plurality of modules are configured to form a build layer of a different thickness.

19. The additive manufacturing apparatus of claim 7, wherein at least one chamber in the plurality of build modules has a circular cross-sectional profile.

20. The additive manufacturing apparatus of claim 7, wherein at least one chamber in the plurality of build modules has a rectilinear cross-sectional profile.
